(19) United States
(12) Patent Application Publication
(10) Pub. No.: US 2026/0003929 A1
(43) Pub. Date: Jan. 1, 2026

(54) MCR-ALS-Based Mixture System Matrix Spectrum Removal Method

(71) Applicant: Shanghai Oceanhood Opto-electronics Tech Co., Ltd., Shanghai (CN)

(72) Inventors: Yongai YU, Shanghai (CN); Zixuan LI, Shanghai (CN); Zhaobin Deng, Shanghai (CN)

(73) Assignee: Shanghai Oceanhood Opto-electronics Tech Co., Ltd., Shanghai (CN)

(21) Appl. No.: 19/131,633

(22) PCT Filed: Dec. 25, 2024
(86) PCT No.: PCT/CN2024/142387

§ 371 Date: May 21, 2025

(30) Foreign Application Priority Data
Dec. 28, 2023 (CN) 202311849001.9

(51) Int. Cl. G06F 17/11; G01N 21/65

(52) U.S. Cl. CPC G06F 17/11; G01N 21/65

(57) ABSTRACT

Disclosed is an MCR-ALS-based mixture system matrix spectrum removal method, including: S1) acquiring an original mixed spectrum including a target substance and a matrix and an original matrix spectrum including only the matrix; S2) performing baseline correction and normalization processing to obtain a pre-processed mixed spectrum D and a pre-processed matrix spectrum B; S3) resolving, via the MCR-ALS algorithm through iterative optimization, a pure component spectral matrix S and a weight matrix C corresponding to the matrix and the target substance; S4) reducing the target substance spectrum and the matrix spectrum according to the matrices S and C; S5) matching the decomposed matrix spectrum with a known standard matrix spectrum, and performing qualitative identification; and S6) calculating an interpretation variance of the generated spectrum from the original spectrum. The present disclosure can completely remove the matrix substance spectrum in the mixture spectrum, and has less influence on a characteristic peak of the target substance spectrum; and therefore, the influence of the matrix spectrum on the characteristic peak of the target substance spectrum is reduced, and the subsequent quantitative and qualitative analysis is facilitated.

### TECHNICAL FIELD

The present disclosure relates to a spectrum processing method, and more particularly relates to an MCR-ALS-based mixture system matrix spectrum removal method.

### BACKGROUND ART

A matrix refers to a solvent such as water in a substance packaging material and a mixture. At present, there are mainly the following methods to eliminate matrix interference.

### 1. Spectral Subtraction Method

In the patent document CN104749155B, a Raman spectrum detection method is provided. Firstly, a matrix spectrum and a mixed spectrum of a matrix and a sample are acquired, the two spectra are quotiented, a minimum value is taken as a coefficient, and the matrix spectrum is multiplied by the coefficient and subtracted from the mixed spectrum.

In a patent of the Raman spectrum detection method for deducting package interference of the patent document CN108169201B, a Raman spectral signal of a package is gradually subtracted from a Raman spectral signal of a sample to be detected with the package, so as to obtain a series of Raman spectral signals with the package interference deducted; information entropy of each of a series of Raman spectral signals with the package interference deducted is calculated; the information entropy of the Raman spectral signal greater than the package is taken as a candidate information entropy sequence, and minimum information entropy is selected therefrom; and the Raman spectral signal with the package interference deducted corresponding to the minimum information entropy is taken as the optimized Raman spectral signal with the package interference deducted.

In a method for detecting a liquid preparation by utilizing a Raman spectrum in the patent document CN103063648B, a Raman spectrum detection method for removing solvent interference is disclosed, including the steps of: measuring a Raman spectrum of a solution including a solvent and a sample to obtain a Raman spectral signal of the solution; measuring a Raman spectrum of the solvent to obtain a Raman spectral signal of the solvent; step-wise subtracting the Raman spectral signal of the solvent from the Raman spectral signal of the solution to obtain a series of Raman spectral signals with solvent interference removed; calculating information entropy of each of a series of Raman spectral signals with solvent interference removed; selecting a maximum information entropy of a series of information entropy calculated; and taking the Raman spectral signal with solvent interference removed corresponding to the maximum information entropy as the optimized Raman spectral signal with solvent interference removed.

### 2. Spectrum Unfolding Method

In the patent document CN113984736A, a packaged food signal separation method based on a spatial offset Raman spectrum is provided. Based on information entropy of the Raman spectrum at different offset distances, the Raman spectrum in a range of some regions is intercepted from initial spectral data as observed data, independent component analysis is performed on the observed data to obtain several independent signal components by separation, the attribution problem of the independent signal components obtained by the independent component analysis and the separation is solved in combination with characteristic spectrum peak cluster identification, and a Raman signal of the internal food to be detected is finally determined.

The existing methods for eliminating matrix interference mainly have the following problems.

1. In many cases, the presence of the matrix may have influence on the spectrum of the target substance, which may make the characteristic peak of the target substance not obvious, and may have influence on some subsequent quantitative or qualitative analysis; and even when the characteristic peak of the matrix Raman spectrum coincides with the target substance, the analysis of the target substance may be seriously influenced.

2. In this method, a background spectrum is subtracted from the original mixed spectrum, the background spectrum needs to be multiplied by a coefficient, and a magnitude of the coefficient is related to the effect of removing a background signal. It is difficult to determine an appropriate coefficient value, a too large coefficient may destroy the Raman signal of some target substances, and a too small coefficient may result in unclean background deduction.

3. Some spectrum unfolding algorithms require multiple measurements of the spectrum, and the measurement process and the calculation process are complex. Therefore, there is a need for improvement on the existing methods for eliminating matrix interference.

### SUMMARY OF THE INVENTION

The technical problem to be solved by the present disclosure is to provide an MCR-ALS-based mixture system matrix spectrum removal method which can completely remove a matrix substance spectrum in a mixture spectrum, and has no influence on a characteristic peak of a target substance spectrum; and therefore, the influence of the matrix spectrum on the characteristic peak of the target substance spectrum is reduced, and the subsequent quantitative and qualitative analysis is facilitated.

The technical solution adopted in the present disclosure to solve the above technical problem is to provide an MCR-ALS-based mixture system matrix spectrum removal method, including the steps of: S1) acquiring an original mixed spectrum including a target substance and a matrix and an original matrix spectrum including only the matrix; S2) performing baseline correction and normalization processing on the original mixed spectrum and the original matrix spectrum to obtain a pre-processed mixed spectrum D and a pre-processed matrix spectrum B; S3) resolving, via the MCR-ALS algorithm through iterative optimization, a pure component spectral matrix S and a weight matrix C corresponding to the matrix and the target substance; S4) reducing the target substance spectrum according to the pure substance spectral matrix and the weight matrix; S5) matching the decomposed matrix spectrum with a standard matrix spectrum, and performing qualitative identification to ensure the accuracy of the separated matrix spectrum; and S6) calculating an interpretation variance of the spectrum generated by MCR-ALS from the original spectrum for evaluating a decomposition result.

Further, in the step S3), the MCR-ALS algorithm is adopted for performing a condition constraint in an iteration process and controlling values of the weight matrix C and the pure substance base spectral matrix S to be not negative, and the base spectral matrix S does not have a negative peak.

Further, the step S3) includes: S31) establishing a mixed system: D=C·S^{T}+E; wherein E is an error matrix; S32) initializing the weight matrix C and the pure substance base spectral matrix S; wherein random initialization is performed on the weight matrix C, in the base spectral matrix S, a first component initial value is the pre-processed matrix spectrum B, and the random initialization is performed on a second component initial value; and initial values of the weight matrix C and the base spectral matrix S are all positive numbers; S33) adopting an alternating least squares method to control the iterative process.

Further, in the step S33), a residual error of two adjacent iterations is detected, when the residual error of the two adjacent iterations is less than 0.0001, the iterations end, or when the number of the iterations is more than 150, the iterations end.

Further, in the step S5), a degree of similarity of the decomposed matrix spectrum to the standard matrix spectrum is evaluated by calculating a spectral angular distance.

Further, the spectral angular distance is calculated as follows:

$$θ ( B , {S}_{0} ) = {cos}^{- 1} ( \frac{{BS}_{0}}{‖ B ‖ ‖ {S}_{0} ‖} ) ;$$

S₀ is a first substance in the base spectral matrix S after iterative decomposition is completed, namely, a substance base spectrum.

Further, in the step S6), the decomposition result is evaluated by calculating data interpretation variance:

$${R}^{2} = \frac{\sum {{d}^{2}}_{ij} - \sum {e}_{ij}^{2}}{\sum {d}_{ij}^{2}} ;$$

the closer the data interpretation variance R² is to 1, the better the effect is, in dᵢⱼϵD, D is the pre-processed mixed spectrum, and e is an error between the spectrum calculated by MCR-ALS and the original mixed spectrum.

Compared with the prior art, the present disclosure has the following beneficial effects: the MCR-ALS-based mixture system matrix spectrum removal method provided in the present disclosure can completely remove the matrix substance spectrum in the mixture spectrum, and has no influence on a characteristic peak of the target substance spectrum; and therefore, the influence of the matrix spectrum on the characteristic peak of the target substance spectrum is reduced, and the subsequent quantitative and qualitative analysis is facilitated.

### BRIEF DESCRIPTION OF THE DRAWINGS

FIG. 1 is a schematic diagram of an MCR-ALS-based mixture system matrix spectrum removal process of the present disclosure;

FIG. 2 is a diagram showing original spectra of a matrix spectrum and a mixture spectrum in an example of the present disclosure;

FIG. 3 is a diagram showing pre-processed spectra of the matrix spectrum and the mixture spectrum in an example of the present disclosure;

FIG. 4 is a diagram showing a base spectrum of a matrix S obtained by decomposition of the present disclosure; and

FIG. 5 is a diagram showing a reduced substance spectrum and matrix spectrum.

### DETAILED DESCRIPTION OF THE INVENTION

The present disclosure will now be further described in conjunction with the accompanying drawings and examples.

The present disclosure provides a method for removing a matrix spectrum of a Raman spectrum based on an MCR-ALS algorithm, which may effectively solve the existing technical problems. Multivariate Curve Resolution Alternating Least Squares (MCR-ALS) is a multivariate curve resolution method which is mainly used to solve the problem of mixing in multispectral and multichromatographic data.

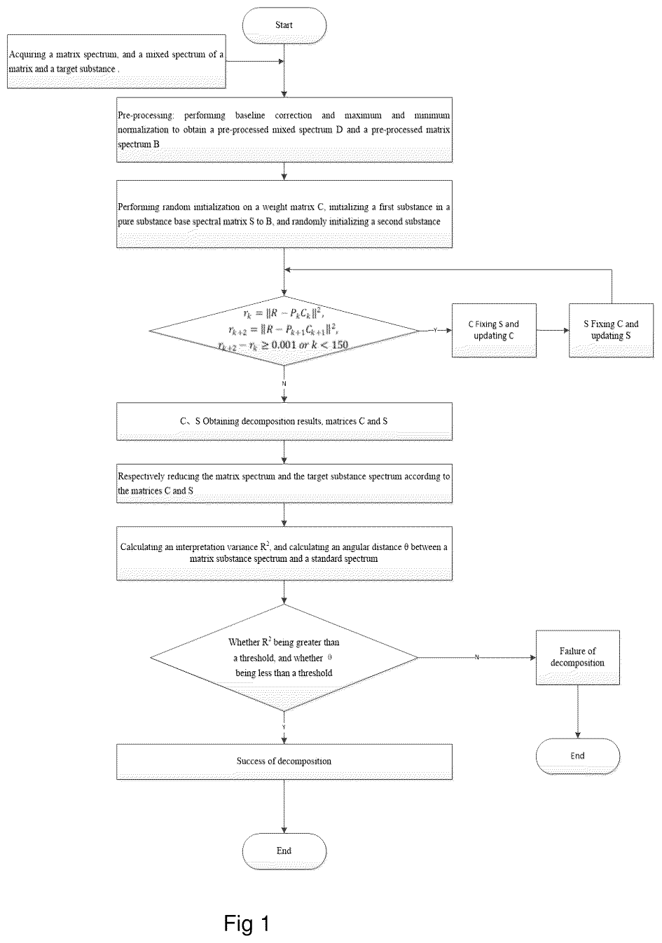

Referring to FIG. 1, a method for removing a matrix Raman signal based on an MCR-ALS algorithm provided in the present disclosure, including the steps of: S1: acquiring original mixed spectrum data and a matrix spectrum, namely, an original mixed spectrum including a target substance and a matrix and a spectrum including only the matrix; S2: performing baseline correction and normalization processing on the original mixed spectrum and the spectrum including only the matrix to obtain a pre-processed mixed spectrum D and a pre-processed matrix spectrum B; S3: performing the MCR-ALS algorithm, and performing a condition constraint in an iteration process, wherein a value of the matrix cannot be negative, and a base spectral matrix S cannot have a negative peak, and the like; obtaining a pure substance base spectral matrix S and a weight matrix C of the matrix and the target substance; S4: reducing the target substance spectrum and the matrix spectrum according to the pure substance base spectral matrix S and the weight matrix C; S5: matching the decomposed matrix spectrum with a standard matrix spectrum, and performing qualitative identification to ensure the accuracy of the separated matrix spectrum; and S6: calculating an interpretation variance of the spectrum generated by MCR-ALS from the original spectrum for evaluating a decomposition result.

The present disclosure can ensure that the matrix spectrum subjected to the MCR-ALS algorithm is correct, without subtracting a wrong signal in the subsequent algorithm; and ensure that an error between the synthesized spectrum after decomposition and the original spectrum is within a reasonable range. These data are used to determine whether the pure substance spectrum obtained by the decomposition is correct. Hereinafter, the main steps of the present disclosure will be described in detail.

### I. a Data Set Required by an Algorithm is Firstly Acquired

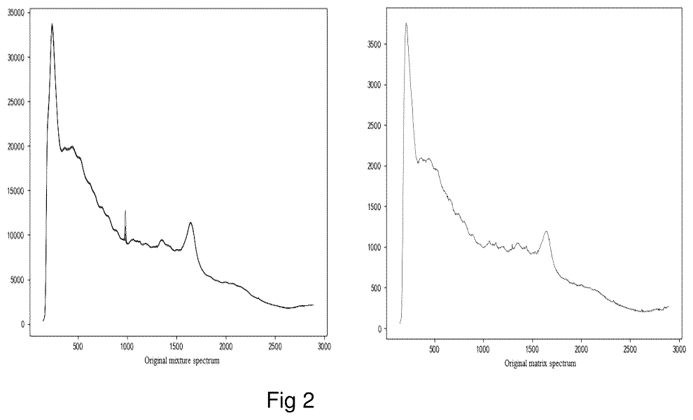

In the present disclosure, an MCR-ALS algorithm is used to remove a background spectrum to require to acquire a pure matrix spectrum and a mixed spectrum of a matrix and a substance. In experiments of the present disclosure, five spectra of NH₄⁺ aqueous solutions of different concentrations are acquired, wherein NH₄⁺ is a target substance, and water is a matrix to be removed; and FIG. 2 shows original spectra of the matrix spectrum and a mixture spectrum.

### II. Spectral Pre-Processing

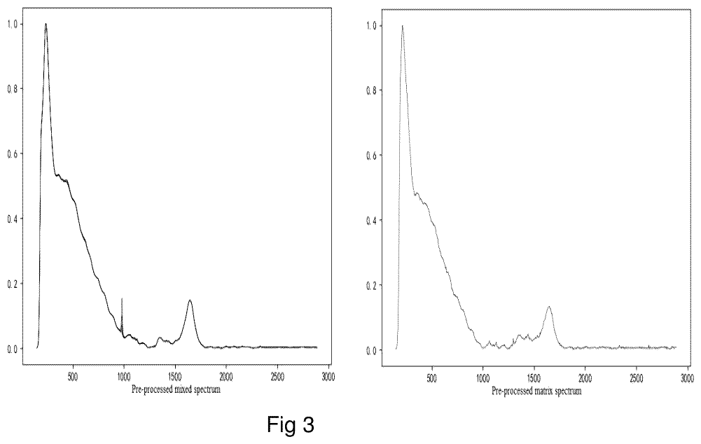

For these spectral data, baseline correction and normalization operation need to be performed respectively, as shown in FIG. 3.

### III. MCR-ALS Iteration

The matrix spectrum is removed from the original spectrum by using the MCR-ALS algorithm.

Multivariate Curve Resolution Alternating Least Squares (MCR-ALS) is a multivariate curve resolution method which is mainly used to solve the problem of mixing in multispectral and multichromatographic data. The core idea of the algorithm is to decompose original data into a plurality of components, wherein each component corresponds to the spectrum or chromatogram of one substance and a relative concentration thereof in each measurement. The main steps of the algorithm are as follows.

### 1. a Mixed System is Established:

$$D = C \cdot {S}^{T} + E ;$$

Wherein D is a mixed spectrum of a matrix and a substance, C is a weight matrix related to a concentration, S is a pure substance base spectral matrix spectrum, T is a matrix transpose symbol, and E is an error matrix.

### 2. Weight and Pure Component Matrices are Initialized

Parameters of the two matrices of the algorithm are initialized, some initial guesses are generally adopted, or random numbers are generated to be taken as initial values of the matrices. In the present disclosure, the number of target components decomposed by MCR-ALS is two, namely, it is decomposed into a matrix spectrum and a substance spectrum. When the matrices are initialized, random initialization is performed on the weight matrix C, in the substance base spectral matrix S, a first component initial value is the matrix spectrum, and a second component is the substance spectrum.

Since negative values do not occur in the two matrices according to the known information, a non-negativity constraint is required to be performed in the iteration process.

In this experiment, D is a 5×1024 mixed substance spectral matrix, C is a randomly initialized matrix with a size of 5×2, and S is a 2×1024 matrix, wherein a first line of data is initialized to matrix spectral data, and a second line is randomly initialized. The values of the matrices C and S are all positive numbers.

### 3. Alternating Least Squares

Alternating Least Squares (ALS) is an iterative optimization algorithm which is often used to solve the least squares problem. Its basic idea is to decompose the least squares problem of multiple variables into the least squares problem of a single variable, and solve the problem by alternating iterations. The ALS algorithm is generally used to process the problems such as matrix decomposition, regression, and least squares support vector machines.

For example: with regard to the optimization of the problem of min_{X,Y}∥A−XY∥², alternating iterative optimization of X, Y is performed, only one of the matrices is optimized at a time, while the other remains fixed, which is equivalent to conversion into the solution of a common least squares problem.

The least squares method is discovered by Legendre in the 19th century, and a matrix form thereof is shown as the following formula:
for n independent variables X=[x₁, x₂, . . . , xₙ], and dependent variables [y₁, y₂, . . . , yₙ], there are:

$$[ \begin{matrix}{x}_{0}^{0} , & {x}_{0}^{1} , & {x}_{0}^{2} , & … , & {x}_{0}^{n} \\ {x}_{1}^{0} , & {x}_{1}^{1} , & {x}_{1}^{2} , & … , & {x}_{1}^{n} \\ ⋮ & ⋮ & ⋮ & ⋱ & ⋮ \\ {x}_{n}^{0} , & {x}_{n}^{1} , & {x}_{n}^{2} , & … & {x}_{n}^{n}\end{matrix} ] [ \begin{matrix}{a}_{0} \\ {a}_{1} \\ ⋮ \\ {a}_{n}\end{matrix} ] = [ \begin{matrix}{y}_{1} \\ {y}_{2} \\ ⋮ \\ {y}_{n}\end{matrix} ]$$

namely, AX=Y.

To minimize a residual error, minε|AX−Y|², an observed value Y is multiple sets of samples of the present disclosure, and a theoretical value AX is a hypothetical fit function of the present disclosure. An objective function is a loss function, and an object of the present disclosure is to obtain a model of a fitting function when the objective function is minimized.

Finally, it is converted into solving X=(A^{T}A)⁻¹A^{T}Y to obtain a fitting coefficient.

The ALS algorithm has the advantage of being simple and easy to implement, and compared with other matrix decomposition algorithms, the ALS algorithm is simpler to implement. With better stability, the ALS algorithm is generally less sensitive to the selection of initial values, so that it is easier to converge in practice. Therefore, the ALS algorithm is selected to update the matrix.

In the present disclosure, when performing the alternating least squares, it should be noted that the values of the two decomposed matrices C and S are ensured to be positive numbers, and therefore, after each least squares calculation ends, it is necessary to determine the matrix data, and the data less than or equal to 0 are modified to a minimum number, which is preferably set to be 0.0001 in the present disclosure, and meanwhile it is also prevented that the iteration stops when the matrix value is 0.

After each iteration matrix calculation ends, it is also necessary to constrain peaks of the spectrum to prevent the occurrence of negative peaks and other cases.

### 4. Convergence Determination

Whether the algorithm has converged is checked, and a residual error of two adjacent iterations is detected; and preferably, when the residual error of the two adjacent iterations is less than 0.0001, the iterations end, or when the number of the iterations is more than 150, the iterations end.

### 5. Analysis Results

A final model pure component spectral matrix and a weight spectrum are analyzed, and the matrix spectrum and the target substance spectrum are respectively resolved.

The calculated matrix spectrum is compared with a standard matrix spectrum, and a degree of similarity thereof is evaluated by calculating a spectral angular distance, so as to determine whether decomposition results are wrong.

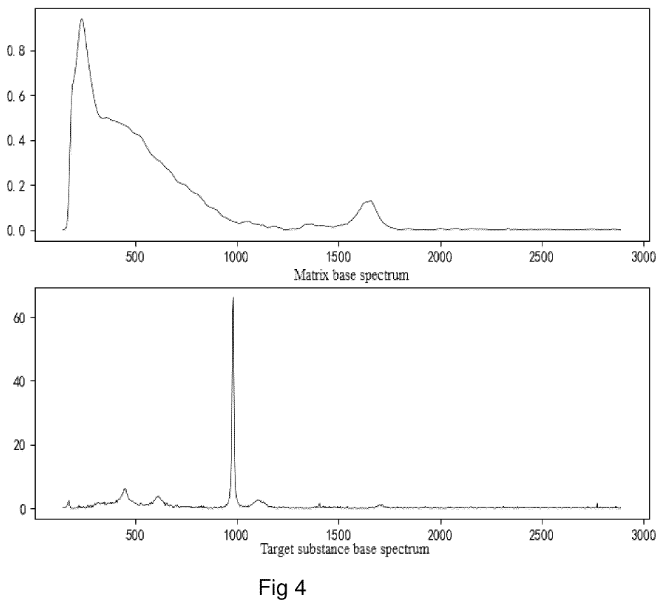

The two components of the base spectrum of the matrix S obtained by decomposition are shown in FIG. 4.

The obtained weight matrix C is shown as follows:

Weight/component

| | Target |
|---|---|
| | substance |
| Matrix | (10⁻⁴) |
| 1.06916 | 4.6879 |
| 1.06915 | 1.4306 |
| 1.06910 | 8.9993 |
| 1.06699 | 17.4884 |
| 1.06728 | 2.6817 |

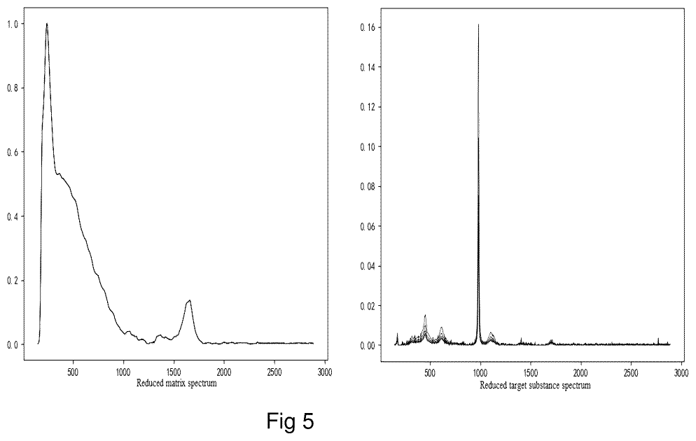

The substance spectrum and the matrix spectrum are recovered according to the matrices S and C, and results of this experiment are shown in FIG. 5.

### 6. Decomposition Effect Analysis

$${R}^{2} = \frac{\sum {{d}^{2}}_{ij} - \sum {e}_{ij}^{2}}{\sum {d}_{ij}^{2}}$$

R² is an interpretation variance, the closer the value of the interpretation variance is to 1, the better the decomposition effect is, in dᵢⱼϵD, D is the pre-processed mixed spectrum, and e is an error between the spectrum calculated by MCR-ALS and the original mixed spectrum.

$$θ ( B , {S}_{0} ) = {cos}^{- 1} ( \frac{{BS}_{0}}{‖ B ‖ ‖ {S}_{0} ‖} )$$

So is a first substance in the base spectral matrix S after iterative decomposition is completed, namely, a substance base spectrum, and B is the pre-processed matrix spectrum; and an angular distance θ between the standard matrix spectrum and the matrix spectrum decomposed by MCR-ALS is calculated, and the similarity between the two spectra is evaluated. The value of the angular distance is between 0 and 90, and the smaller the value is, the better the effect is.

In this experiment, the interpretation variance R² is 0.9868, and the angular distance θ=1.14218.

1. The MCR-ALS algorithm is used to unfold the mixed spectrum, and the matrix spectrum and the substance spectrum are separated to reduce the influence of the matrix spectrum on the target substance spectrum.

2. It is more convenient compared with taking out the substance for measurement, there is no pollution or damage to the substance, and the matrix spectrum is separated more cleanly compared with other spectral subtraction methods.

3. The spectral measurement and data calculation processes in the spectrum unfolding process are also relatively simple.

Although the present disclosure has been described with reference to the preferred examples above, the present disclosure is not to be limited by the examples. Any person skilled in the art may make some modifications and improvements without departing from the spirit and scope of the present disclosure. Therefore, the scope of protection of the present disclosure should be determined by claims.

What is claimed is:

1. An MCR-ALS-based mixture system matrix spectrum removal method, comprising the steps of:
S1) acquiring an original mixed spectrum comprising a target substance and a matrix and an original matrix spectrum comprising only the matrix;
S2) performing baseline correction and normalization processing on the original mixed spectrum and the original matrix spectrum to obtain a pre-processed mixed spectrum D and a pre-processed matrix spectrum B;
S3) resolving, via the MCR-ALS algorithm through iterative optimization, a pure component spectral matrix S and a weight matrix C corresponding to the matrix and the target substance;
S4) reducing the target substance spectrum according to the pure substance base spectral matrix S and the weight matrix C;
S5) matching the decomposed matrix spectrum with a standard matrix spectrum, and performing qualitative identification; and
S6) calculating an interpretation variance of the spectrum generated by MCR-ALS from the original spectrum for evaluating a decomposition result;
wherein in the step S3), the MCR-ALS algorithm is adopted for performing a condition constraint in an iteration process and controlling values of the weight matrix C and the pure substance base spectral matrix S to be not negative, and the base spectral matrix S does not have a negative peak;
the step S3) comprises:
S31) establishing a mixed system: D=C·S^{T}+E;
wherein D is a mixed spectrum of a matrix and a substance, C is a weight matrix related to a concentration, S is a pure substance base spectral matrix spectrum, T is a matrix transpose symbol, and E is an error matrix;
S32) initializing the weight matrix C and the pure substance base spectral matrix S;
wherein random initialization is performed on the weight matrix C, in the base spectral matrix S, a first component initial value is the pre-processed matrix spectrum B, and the random initialization is performed on a second component initial value; and initial values of the weight matrix C and the base spectral matrix S are all positive numbers;
S33) adopting an alternating least squares method to control the iterative process;
wherein in the step S5), a degree of similarity of the decomposed matrix spectrum to the standard matrix spectrum is evaluated by calculating a spectral angular distance; and
the spectral angular distance is calculated as follows:
$$θ ( B , {S}_{0} ) = {cos}^{- 1} ( \frac{{BS}_{0}}{‖ B ‖ ‖ {S}_{0} ‖} ) ;$$
S₀ is a first substance in the base spectral matrix S after iterative decomposition is completed, namely, a substance base spectrum, and B is the pre-processed matrix spectrum.

2. The MCR-ALS-based mixture system matrix spectrum removal method of claim 1, wherein in the step S33), a residual error of two adjacent iterations is detected, when the residual error of the two adjacent iterations is less than 0.0001, the iterations end, or when the number of the iterations is more than 150, the iterations end.

3. The MCR-ALS-based mixture system matrix spectrum removal method of claim 1, wherein in the step S6), the decomposition result is evaluated by calculating data interpretation variance:
$${R}^{2} = \frac{\sum {{d}^{2}}_{ij} - \sum {e}_{ij}^{2}}{\sum {d}_{ij}^{2}} ;$$
the closer the data interpretation variance R² is to 1, the better the effect is, in dᵢⱼϵD, D is the pre-processed mixed spectrum, and e is an error between the spectrum calculated by MCR-ALS and the original mixed spectrum.
